(19) United States
(12) Patent Application Publication
(10) Pub. No.: US 2010/0271518 A1
(43) Pub. Date: Oct. 28, 2010

(54) SOLID-STATE IMAGING DEVICE AND CAMERA SYSTEM

(75) Inventor: Kenji Kobayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/764,265

(22) Filed: Apr. 21, 2010

(30) Foreign Application Priority Data
Apr. 23, 2009 (JP) 2009-105237

(51) Int. Cl. H04N 5/335

(52) U.S. Cl. 348/298; 348/E05.091

(57) ABSTRACT

A solid-state imaging device includes at least a pixel unit, a trigger receiver, a storage controller, and a reading circuit. In the pixel unit, pixels are two-dimensionally arranged in a matrix. The trigger receiver receives a first trigger which is a pre-instruction to start charge storage in the pixels and a second trigger which is an instruction to start the charge storage. The storage controller controls the pixels so as to start and end the charge storage in the pixels of a plurality of rows at the same time after the second trigger is received. The reading circuit reads a reset signal corresponding to one frame before the charge storage is ended after the first trigger is received, and reads a captured image signal corresponding to one frame after the second trigger is received.

### BACKGROUND OF THE INVENTION

1. Field of the Invention

The present invention relates to a solid-state imaging device and a camera system.

Priority is claimed on Japanese Patent Application No. 2009-105237, filed Apr. 23, 2009, the content of which is incorporated herein by reference.

2. Description of Related Art

Solid-state imaging devices and camera systems employing various techniques have been suggested as a solid-state imaging device and a camera system having a global shutter function of exposing all pixels at the same time. For example, Japanese Unexamined Patent Application, First Publication No. 2005-65184 discloses a technique of suppressing noises associated with a reset signal and a captured image signal by reading the captured image signal in the same exposure period for all pixels after reading the reset signal and externally obtaining a difference signal between the captured image signal and the reset signal.

This technique will be specifically described below. FIG. 8 shows the configuration of a solid-state imaging device described in Japanese Unexamined Patent Application, First Publication No. 2005-65184. The solid-state imaging device shown in FIG. 8 includes a pixel unit 8 in which plural unit pixels 7 are arranged two-dimensionally in a matrix. FIG. 9 shows the configuration of a unit pixel 7.

In the unit pixel 7, a photoelectric conversion element 1 is formed of a photo diode and the amount of charges stored therein varies depending on incident light. A charge holding portion 2 holds optical charges stored in the photoelectric conversion element 1. A transfer portion 3 transfers the optical charges of the photoelectric conversion element 1 to the charge holding portion 2. A reset portion 4 resets the charge holding portion 2 to a source potential. A discharge portion 5 resets the photoelectric conversion element 1 to the source potential. A reading portion 6 reads the potential of the charge holding portion 2.

A vertical scanning circuit 30 controls the pixels of the pixel unit 8 by outputting a transfer control signal φTX1, a reset control signal φRES(m), a discharge control signal φTX2, and a reading control signal φSEL(m) for controlling the ON and OFF of the transfer portion 3, the reset portion 4, the discharge portion 5, and the reading portion 6 for each row of the pixel unit 8. In addition, the subscript m (where m=1, 2, . . . n) of φRES(m) and φSEL(m) represents a row position.

A horizontal scanning circuit 31 selects a pixel column from which a signal should be read and outputs a pixel signal of the pixel column. An A/D converter 32 converts the signal, which is read from the reading portion 6 of each pixel via the horizontal scanning circuit 31, in an A/D conversion manner. A noise suppressing circuit 33 suppresses noises of the pixel signals output from the horizontal scanning circuit 31. The noise suppressing circuit 33 includes a frame memory 34 storing the signal converted in the A/D conversion manner by the A/D converter 32 and an adder 35 performing a subtraction operation. A controller 36 is configured to perform a control corresponding to an external setting signal applied from the outside by applying control signals to the vertical scanning circuit 30, the horizontal scanning circuit 31, the noise suppressing circuit 33, and other circuits.

Operations of the solid-state imaging device shown in FIG. 8 will be described with reference to the timing diagram shown in FIG. 10.

As shown in FIG. 10, when a signal indicating the imaging start is input, first, a reset control signal φRES(1) of the first row is changed from the L level to the H level to turn on the reset portions 4 of the first row and the charge holding portions 2 of the first row are reset to a source potential. Subsequently, the reset control signal φRES(1) is changed from the H level to the L level to turn off the reset portions 4, and a reading control signal φSEL(1) of the first row is changed to the H level to activate the reading portions 6 of the first row, whereby the potential right after the reset is read as a reset signal via the horizontal scanning circuit 31.

The read reset signal corresponding to one row is converted in an A/D conversion manner by the A/D converter 32. The converted reset signal corresponding to one row is stored in the frame memory 34. The reset signal reading operation is ended at the time point when this operation is sequentially carried out on all rows and the reset signal of the final row is stored in the frame memory 34. The period until the reset signal reading operation ends after the signal indicating the imaging start is input is a reset signal reading period.

After the reset signal reading operation is finished, the discharge control signal φTX2 is changed from the H level to the L level to turn off the discharge portions 5 of all the pixels in a bundle. Accordingly, the exposure (charge storage) of all the pixels is started. At a bundle-pixel transfer time after a predetermined exposure time, the transfer control signal φTX1 is changed to the H level to turn on the transfer portions 3 of all the pixels at the same time, whereby optical charges stored in the photoelectric conversion elements 1 are transferred to the charge holding portions 2 in a bundle. That is, the exposure is ended. The period from the exposure start (charge storage start) to the exposure end (charge storage end) is the exposure period.

When the exposure is ended, the reading control signal φSEL(m) is changed to the H level sequentially from the first row to activate the reading portions 6, whereby captured image signals are read via the horizontal scanning circuit 31. The read captured image signals corresponding to one row are converted in the A/D conversion manner by the A/D converter 32.

At this time, the reset signal of the first row stored in the frame memory 34 in the reset signal reading period is read from the frame memory 34 and the reset signal of the first row is subtracted from the captured image signals of the first row by the adder 35. This operation is sequentially performed on all the rows and ends at the time point when the reset signal of the final row is subtracted from the captured image signal of the final row. The period from the expiry of the exposure period until the subtraction of the reset signal from the captured image signal of all the rows ends is a captured image signal reading period.

In this way, the signal reading technique (including the suppression of noises) associated with pixel information and performed in Japanese Unexamined Patent Application, First Publication No. 2005-65184 is carried out. In this technique, since the reset signal is read after the signal indicating the imaging start is input and the storage of charges is started thereafter, there is a problem in that time is taken until the exposure is started, that is, a problem that a release time lag is elongated.

To reduce the release time lag, a technique of shortening the release time lag by performing reading of the reset signal at the same time as reading the captured image signal in the exposure period is described, for example, in Japanese Unexamined Patent Application, First Publication No. 2008-28517. This technique will be specifically described below.

The configuration of a solid-state imaging device shown in FIG. 8 will be described below. The method of driving the solid-state imaging device will be described when the exposure time is shorter than a frame reading time which is the time of reading the reset signal from all the rows and when the exposure time is longer than the frame reading time.

FIG. 11 is a timing diagram when the exposure time is shorter than the frame reading time. In this case, the exposure is started in the reset signal reading period.

As shown in FIG. 11, when the signal indicating the imaging start is input, first, a reset control signal φRES(1) of the first row is changed from the L level to the H level to turn on the reset portions 4 of the first row and the charge holding portions 2 of the first row are reset to a source potential. Subsequently, the reset control signal φRES(1) is changed from the H level to the L level to turn off the reset portions 4, and a reading control signal φSEL(1) of the row is then changed to the H level to activate the reading portions 6 of the first row, whereby the potential right after the reset is read as a reset signal via the horizontal scanning circuit 31.

The read reset signal corresponding to one row is converted in an A/D conversion manner by the A/D converter 32. The converted reset signal corresponding to one row is stored in the frame memory 34. The reset signal reading operation is ended at the time point when this operation is sequentially carried out on all the rows and the reset signal of the final row is stored in the frame memory 34.

The discharge control signal φTX2 is changed from the H level to the L level in the course of reading the reset signal to turn off the discharge portions 5 of all the pixels in a bundle, whereby the exposure of all the pixels is started. After a predetermined exposure time, the transfer control signal φTX1 is changed to the H level to turn on the transfer portions 3 of all the pixels at the same time, whereby the optical charges stored in the photoelectric conversion elements 1 are transferred to the charge holding portions 2 in a bundle. That is, the exposure is ended.

When the exposure is ended, the reading control signal φSEL(m) is changed to the H level sequentially from the first row to activate the reading portions 6, whereby the captured image signals are read via the horizontal scanning circuit 31. The read captured image signals corresponding to one row are converted in the A/D conversion manner by the A/D converter 32.

At this time, the reset signal of the first row stored in the frame memory 34 in the reset signal reading period is read from the frame memory 34 and the reset signal of the first row is subtracted from the captured image signals of the first row by the adder 35. This operation is sequentially performed on all the rows and is ended at the time point when the reset signal of the final row is subtracted from the captured image signals of the final row.

FIG. 12 is a timing diagram when the exposure time is longer than the frame reading time. In this case, the exposure is started before the reset signal reading operation is started.

As shown in FIG. 12, when the signal indicating the imaging start is input, first, the discharge control signal φTX2 is changed from the H level to the L level to turn off the discharge portions 5 of all the pixels in a bundle. The reset control signal φRES(1) of the first row is changed from the L level to the H level in the exposure period to reset the charge holding portions 2 of the first row to the source potential. The reading control signal φSEL(1) of the first row is changed to the H level to activate the reading portions 6, whereby the potential right after the reset is read as a reset signal via the horizontal scanning circuit 31.

The read reset signal corresponding to one row is converted in an A/D conversion manner by the A/D converter 32. The converted reset signal corresponding to one row is stored in the frame memory 34. The reset signal reading operation is ended at the time point when this operation is sequentially carried out on all the rows and the reset signal of the final row is stored in the frame memory 34.

After the reading and storage of the reset signal in all the rows is ended, the transfer control signal φTX1 is changed from the L level to the H level to turn on the transfer portions 3 of all the pixels at the same time, whereby the optical charges stored in the photoelectric conversion elements 1 are transferred to the charge holding portions 2 in a bundle. That is, the exposure is ended.

The subsequent operations of reading the captured image signals, converting the captured image signals in the A/D conversion manner, and subtracting the reset signal from the captured image signals are the same as performed when the exposure time is shorter than the frame reading time, and thus a description thereof is omitted here.

By employing the above-mentioned technique, it is possible to shorten the release time lag by the time obtained by subtracting the exposure time from the reset signal reading time of one frame when the exposure time is shorter than the frame reading time. When the exposure time is longer than the frame reading period, it is possible to shorten the release time lag to almost zero.

### SUMMARY OF THE INVENTION

In one aspect of the present invention, there is provided a solid-state imaging device that includes at least: a pixel unit in which pixels are two-dimensionally arranged in a matrix, each pixel including a photoelectric conversion element of which an amount of charges stored therein varies depending on incident light and a charge holding portion which holds the charges stored in the photoelectric conversion element; a trigger receiver which receives a first trigger which is a pre-instruction to start charge storage in the pixels and a second trigger which is an instruction to start the charge storage; a storage controller which controls the pixels so as to start and end the charge storage in the pixels of a plurality of rows at the same time after the second trigger is received; and a reading circuit which reads a reset signal corresponding to one frame before the charge storage is ended by reading the reset signal from each row when the charge holding portion is reset after the first trigger is received, and reads a captured image signal corresponding to one frame by reading the captured image signal corresponding to the charges stored in the photoelectric conversion element from the charge storage start to the charge storage end from each row after the second trigger is received.

Preferably, the storage controller may control the pixels to start the charge storage after the second trigger is received and the reading of the reset signal is ended.

Preferably, the reading circuit may stop the reading of the reset signal at the same time as the charge storage end, and the solid-state imaging device may further include at least: a memory unit which stores position information of the row from which the reset signal is read just before the reading circuit stops the reading of the reset signal; and a reading controller which determines a position of the row from which the reading circuit starts the reading of the captured image signal, based on the position information stored in the memory unit.

Preferably, the solid-state imaging device may further include at least: a memory unit which stores the reset signal read by the reading circuit before the charge storage is ended after the second trigger is received, when the reading circuit repeatedly reads the reset signal corresponding to one frame; and a processing unit which generates a difference signal between the reset signal corresponding to one frame, which is finally stored in the memory unit, and the captured image signal corresponding to one frame.

Moreover, in another aspect of the present invention, there is provided a camera system that includes at least the above-described solid-state imaging device.

### BRIEF DESCRIPTION OF THE DRAWINGS

The above features and advantages of the present invention will be more apparent from the following detailed description of certain preferred embodiments taken in conjunction with the accompanying drawings, in which:

FIG. 1 is a block diagram illustrating the configuration of a solid-state imaging device according to a first embodiment of the invention;

FIG. 2 is a timing diagram illustrating an operation of the solid-state imaging device according to the first embodiment of the invention;

FIG. 3 is a timing diagram illustrating an operation of the solid-state imaging device according to the first embodiment of the invention;

FIG. 4 is a block diagram illustrating the configuration of a solid-state imaging device according to a second embodiment of the invention;

FIG. 5 is a timing diagram illustrating an operation of the solid-state imaging device according to the second embodiment of the invention;

FIG. 6 is a timing diagram illustrating an operation of the solid-state imaging device according to a third embodiment of the invention;

FIG. 7 is a block diagram illustrating the configuration of a camera system employing the solid-state imaging device according to one of the first to third embodiments of the invention;

FIG. 8 is a block diagram illustrating the configuration of a solid-state imaging device;

FIG. 9 is a circuit diagram illustrating the configuration of a pixel;

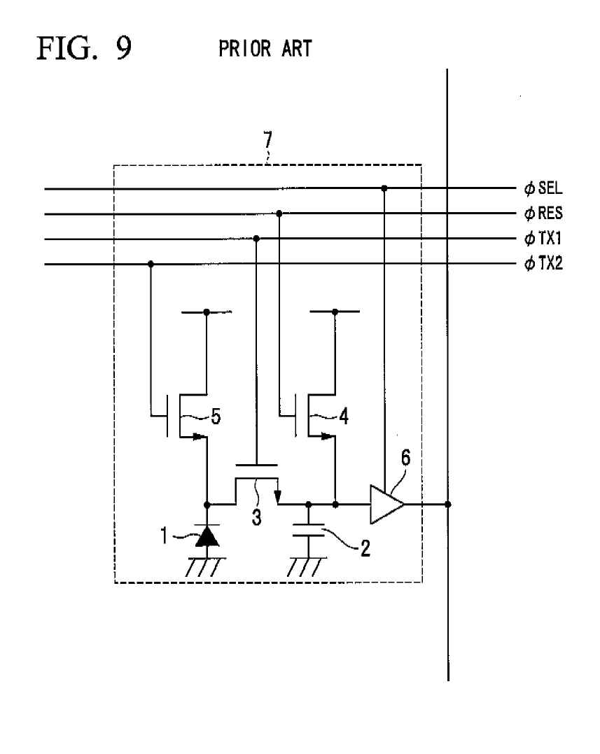

FIG. 10 is a timing diagram illustrating an operation of the solid-state imaging device;

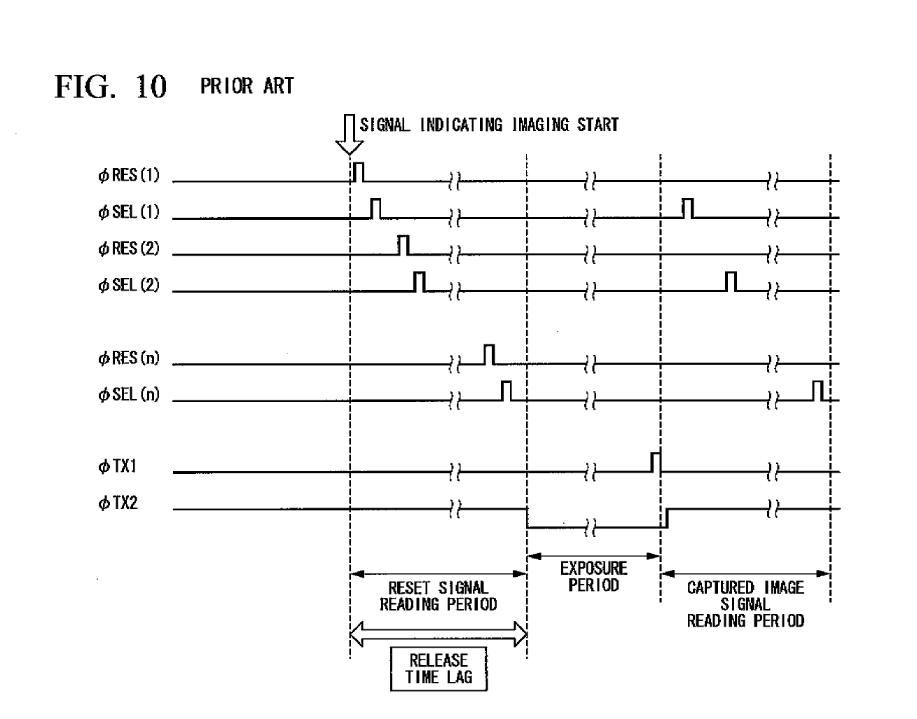

FIG. 11 is a timing diagram illustrating an operation of the solid-state imaging device; and

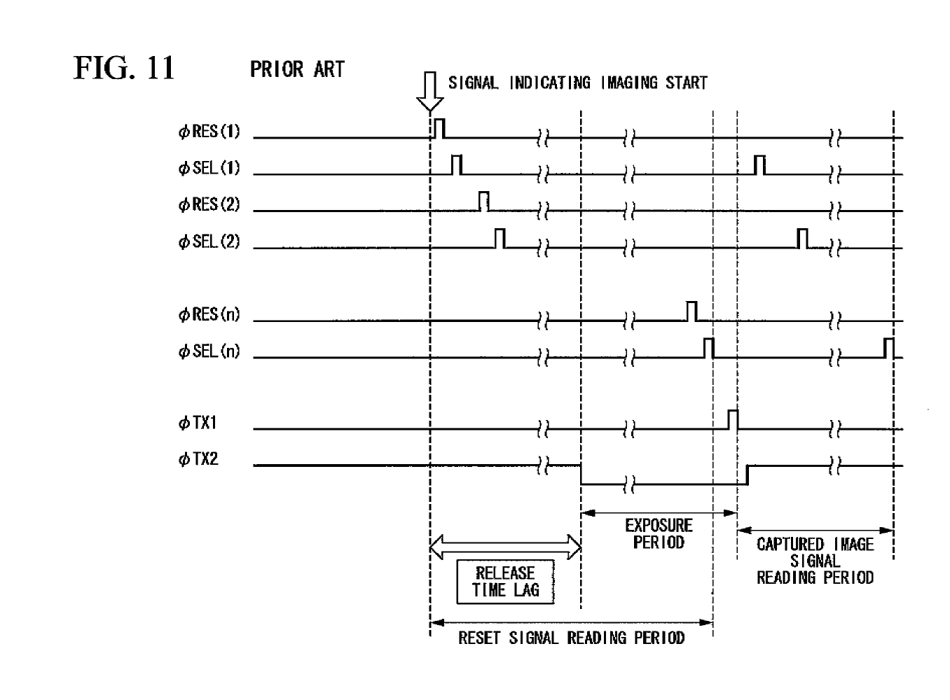

FIG. 12 is a timing diagram illustrating an operation of the solid-state imaging device.

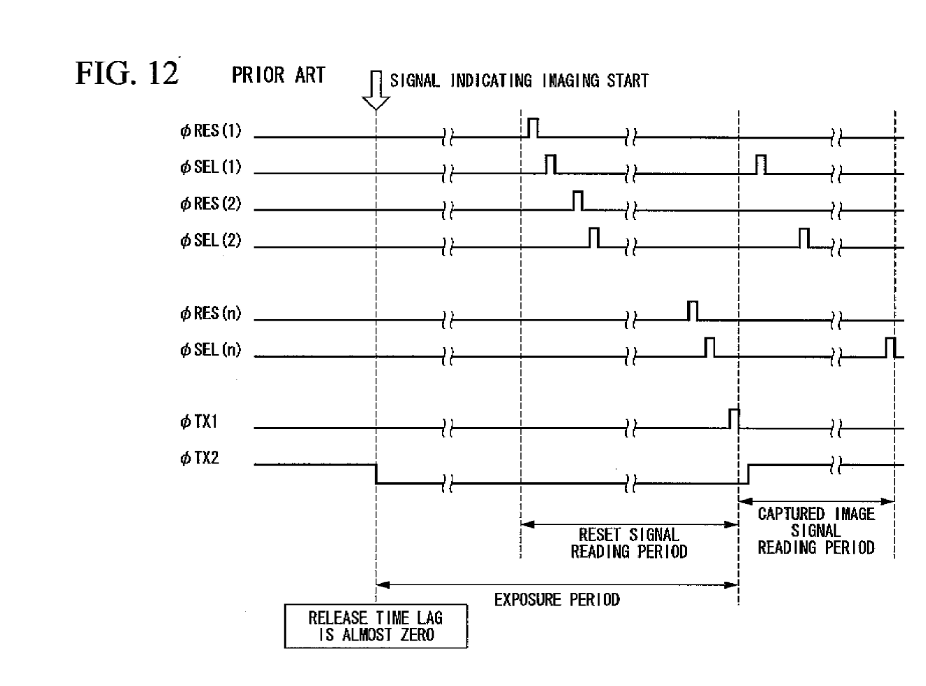

### DETAILED DESCRIPTION OF THE PREFERRED EMBODIMENTS

The present invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, embodiments of the present invention will be described with reference to the drawings.

### First Embodiment

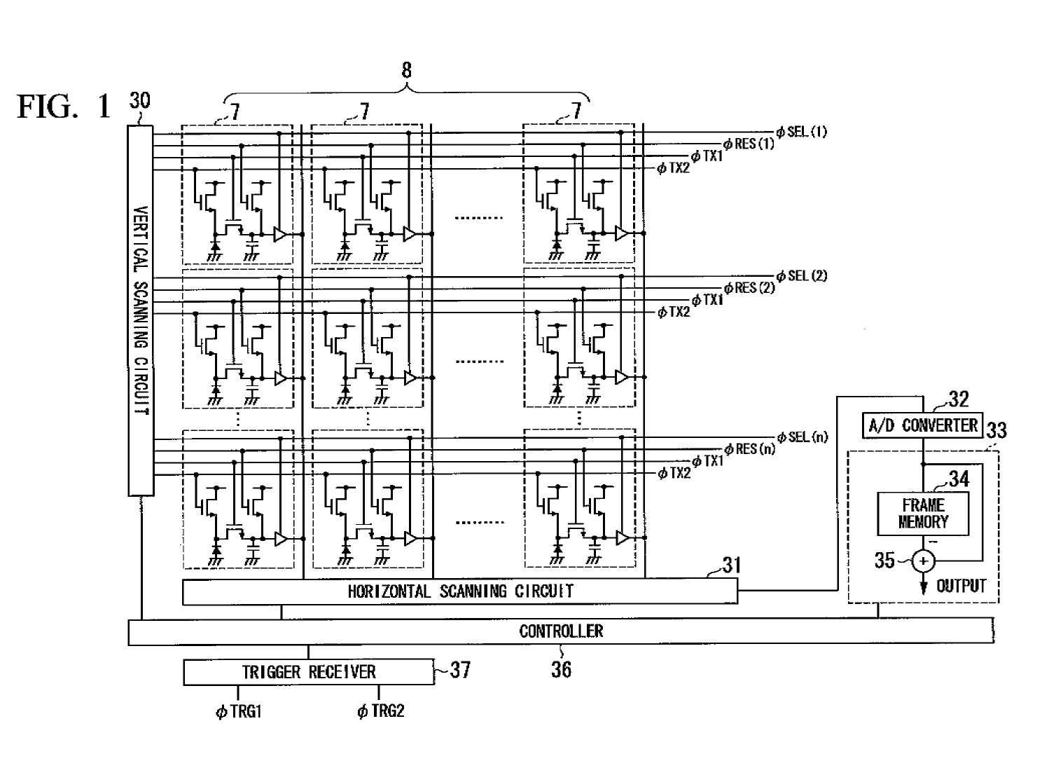

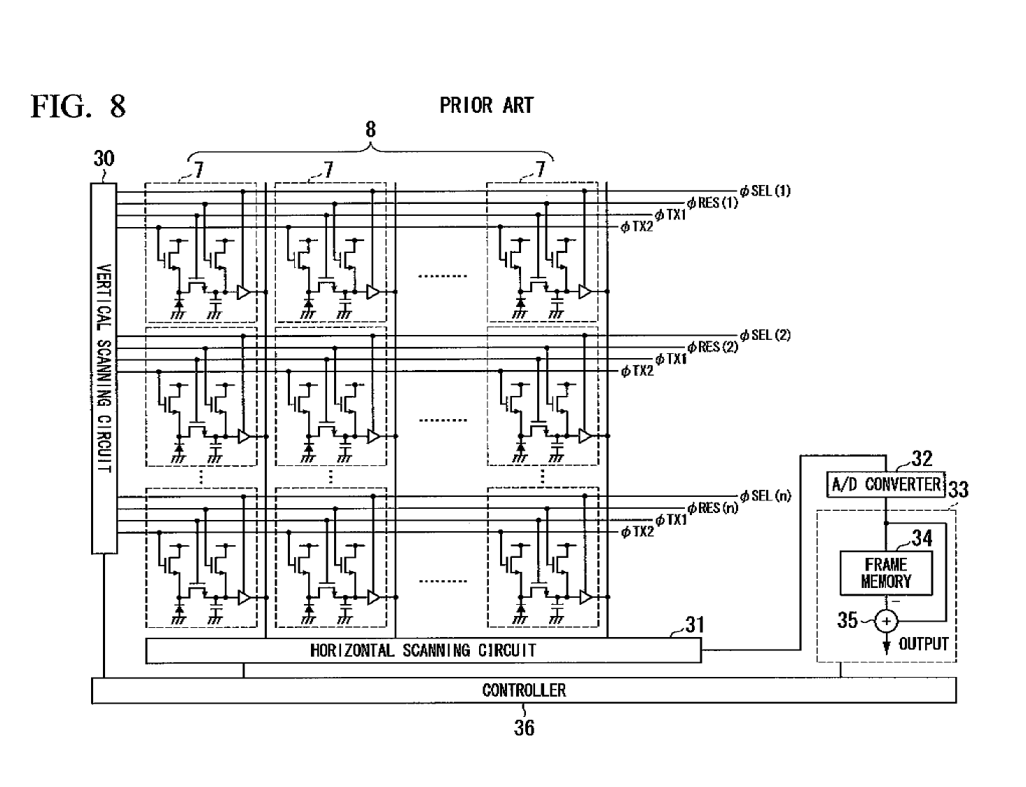

First, a first embodiment of the invention will be described. FIG. 1 shows the configuration of a solid-state imaging device according to this embodiment. The solid-state imaging device shown in FIG. 1 is different from the solid-state imaging device shown in FIG. 8, in that it includes a trigger receiver 37.

A first trigger signal φTRG1 which is a pre-instruction (for example, corresponding to the semi-press of a shutter button) of exposure start (storage start) and a second trigger signal φTRG2 (for example, corresponding to the full-press of the shutter button) of exposure start are input to the trigger receiver 37. The trigger receiver 37 receives the pre-instruction of exposure start and the instruction of exposure start by the use of the first trigger signal φTRG1 and the second trigger signal φTRG2.

When the first trigger signal φTRG1 is input to the trigger receiver 37, a controller 36 is controlled to start repeated reading of a reset signal to be described below. When the second trigger signal φTRG2 is input to the trigger receiver 37, the controller 36 is controlled to start the exposure. The other operations are the same as described in the related art and thus a description thereof is omitted here.

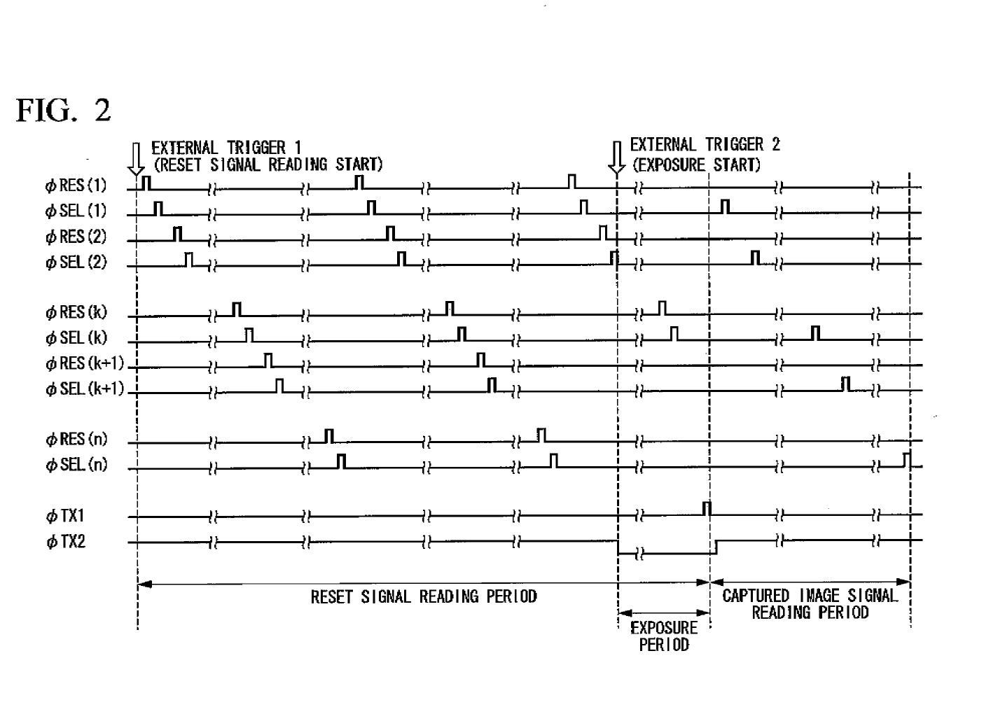

The operation of the solid-state imaging device shown in FIG. 1 will be described below with reference to the timing diagram shown in FIG. 2. As shown in FIG. 2, when the first trigger signal is input to the trigger receiver 37, the reset control signal φRES(1) of the first row is changed from the L level to the H level to turn on the reset portions 4 of the first row, whereby the charge holding portions 2 of the first row are reset to a source potential. Subsequently, the reset control signal φRES(1) is changed from the H level to the L level to turn off the reset portions 4 and the reading control signal φSEL(1) of the first row is changed to the H level to activate the reading portions 6 of the first row, whereby the potential just after the reset is read as the reset signal via the horizontal scanning circuit 31.

The read reset signal corresponding to one row is converted in an A/D conversion manner by the A/D converter 32. The converted reset signal corresponding to one row is stored in the frame memory 34. This operation is sequentially carried out on all the rows and the reset signal of the n-th row which is the final row is stored in the frame memory 34.

Thereafter, the charge holding portions 2 of the first row are reset again, the reset signal is subjected to the reading and the A/D conversion, and the reset signal of the first row stored in the frame memory 34 is overwritten and updated. This operation is carried out sequentially on all the rows. Hereinafter, this operation is called repeated reset signal reading. The repeated reset signal reading operation is repeated until the exposure is ended. The period until the repeated reset signal reading operation is ended after the first trigger signal is input to the trigger receiver 37 is a reset signal reading period.

When the second trigger signal which is the instruction of exposure start is input to the trigger receiver 37 during the repeated reset signal reading operation, the discharge control signal φTX2 is changed from the H level to the L level to turn off the discharge portions 5 of all the pixels in a bundle, whereby the exposure of all the pixels is started. After a predetermined exposure period, the transfer control signal φTX1 is changed to the H level to turn on the transfer portions 3 of all the pixels at the same time, whereby the optical charges stored in the photoelectric conversion elements 1 are transferred to the charge holding portions 2 in a bundle. That is, the exposure is ended. The period from the start of exposure (charge storage start) to the end of exposure (charge storage end) is an exposure period.

When the exposure is ended, the reading control signal φSEL(m) is changed to the H level sequentially from the first row to activate the reading portions 6, whereby the captured image signals are read via the horizontal scanning circuit 31. The read captured image signals corresponding to one row are converted in the A/D conversion manner by the A/D converter 32.

At this time, the reset signal of the first row stored in the frame memory 34 in the reset signal reading period is read from the frame memory 34 and the reset signal of the first row is subtracted from the captured image signals of the first row by the adder 35. This operation is sequentially performed on all the rows and is ended at the time point when the reset signal of the final row is subtracted from the captured image signals of the final row.

As described above, according to this embodiment, the repeated reset signal reading operation corresponding to one frame is performed after the first trigger signal is input to the trigger receiver 37. Accordingly, when the exposure time is shorter than the frame reading time, it is possible to read and store the reset signal corresponding to one frame in the frame memory 34 until the end of the exposure. Therefore, it is possible to start the exposure just after the second trigger signal is input to the trigger receiver 37, thereby reducing the release time lag to almost zero.

Since the reset signal read in the final frame among the repeatedly-read reset signals is subtracted from the captured image signals, it is possible to remove the noises such as fixed pattern noises and random noises associated with the captured image signals and the reset signals, thereby obtaining high-quality image signals.

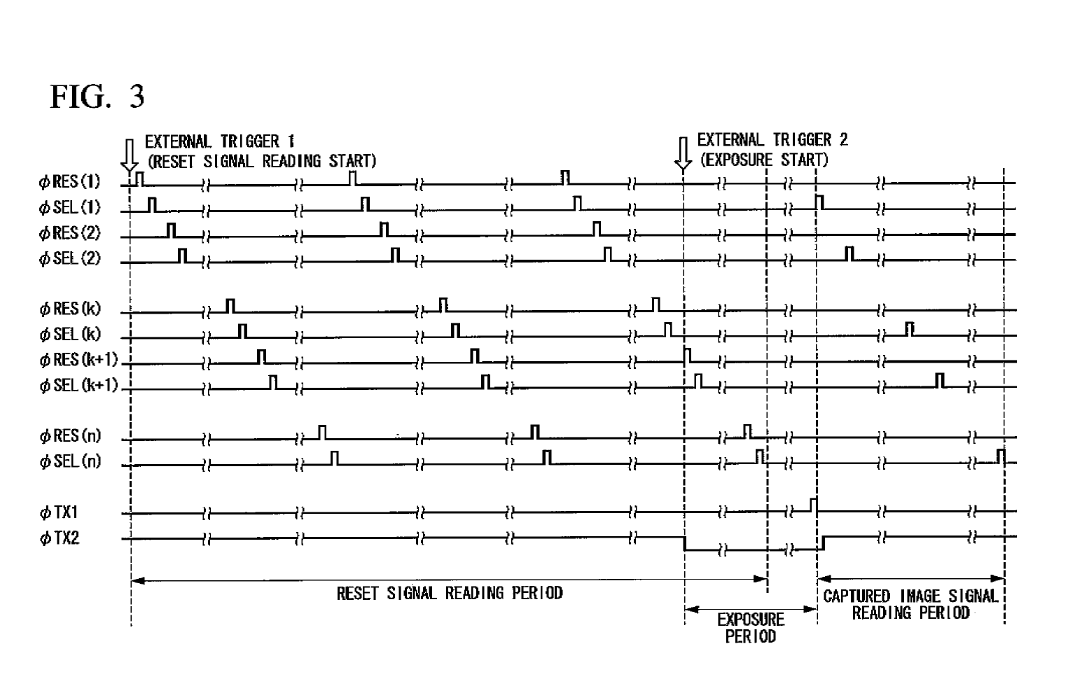

As shown in FIG. 3, when the reset signal reading operation corresponding to all the rows is ended during the exposure period, the repeated reset signal reading operation may be ended at that time.

### Second Embodiment

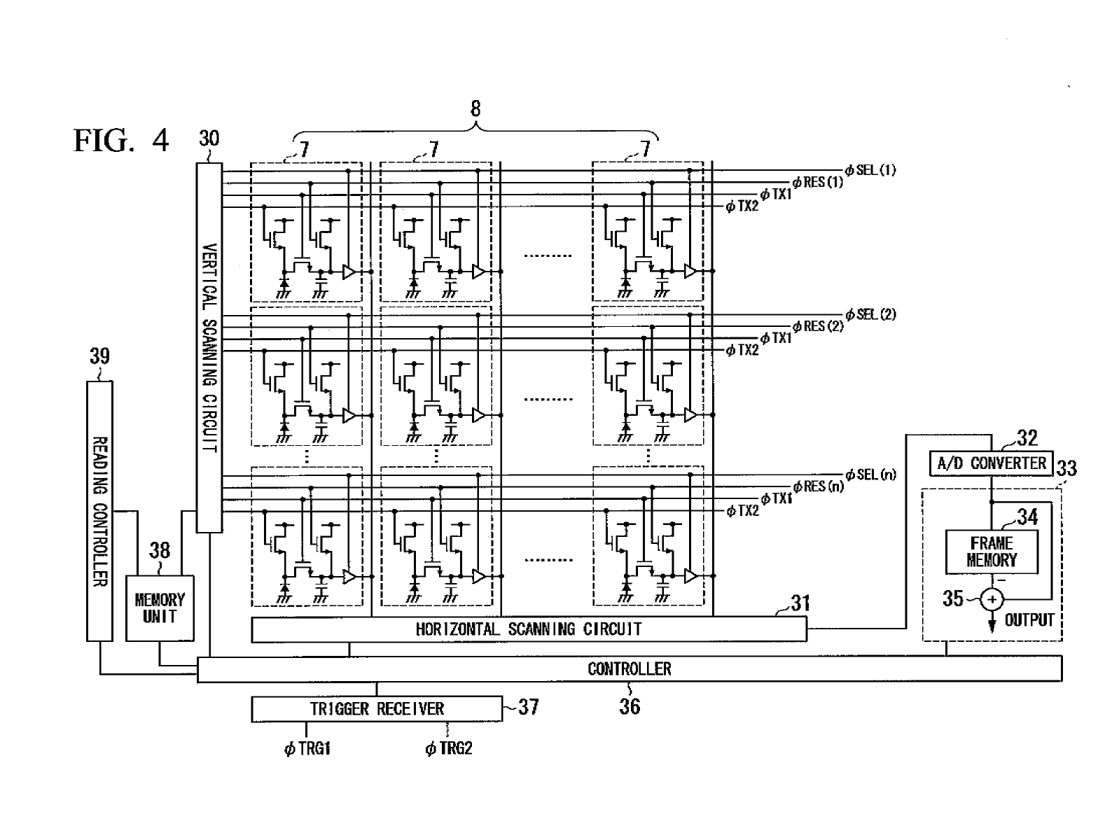

A second embodiment of the invention will be described below. FIG. 4 is a diagram illustrating the configuration of the solid-state imaging device according to this embodiment. The configuration shown in FIG. 4 is different from the configuration shown in FIG. 1, in that it includes a memory unit 38 and a reading controller 39.

The memory unit 38 stores information (position information) on a position of the row from which the reset signal is finally read. The reading controller 39 determines the row position from which the captured image signal is read on the basis of the information stored in the memory unit 38 and controls the controller 36 to perform the operation of reading the operation signal on the basis of the determination. The other operation is the same as described in the first embodiment and thus an explanation thereof is omitted here.

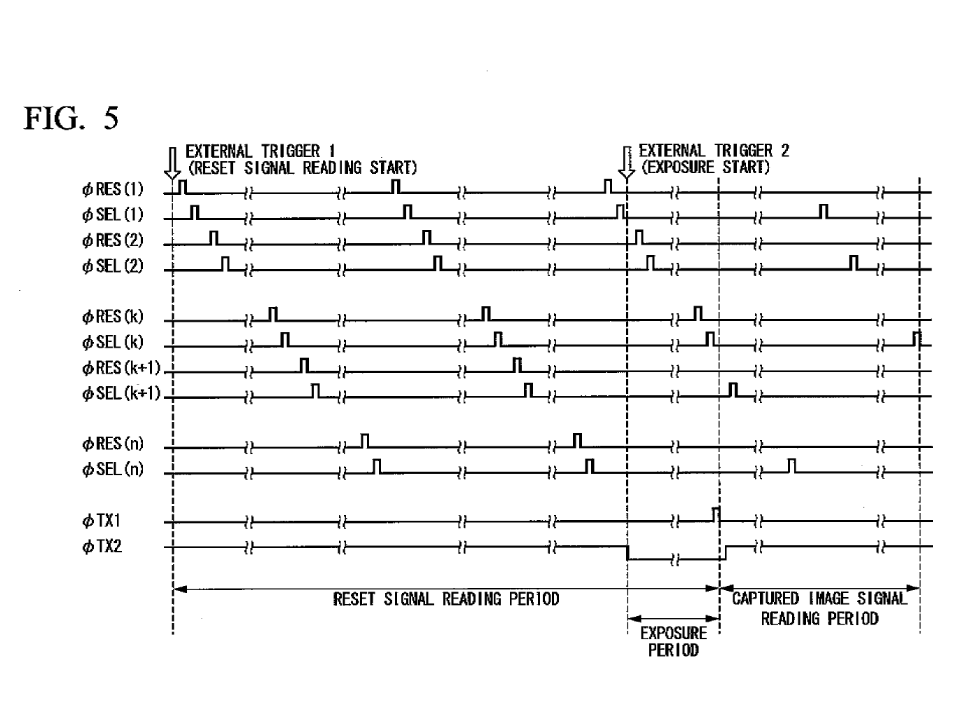

The operations of the solid-state imaging device shown in FIG. 4 will be described with reference to the timing diagram shown in FIG. 5. The operations until the exposure end are the same as described with reference to the timing diagram shown in FIG. 2 and thus an explanation thereof is omitted here. Here, the final row from which the reset signal is read is the k-th row and information indicating the row position thereof is stored in the memory unit 38.

As shown in FIG. 5, the reading of the captured image signal is started from the (k+1)-th row subsequent to the final row from which the reset signal is read on the basis of the information stored in the memory unit 38 after the end of exposure. The read captured image signal of the (k+1)-th row is converted in the A/D conversion manner by the A/D converter 32. At this time, the reset signal of the (k+1)-th row stored in the frame memory 34 is read from the frame memory 34 in the reset signal reading period and the reset signal of the (k+1)-th row is subtracted from the captured image signal of the first row by the adder 35. This operation is sequentially performed on all the rows in the order of the (k+2)-th row, . . . , the n-th row, the first row, the second row, . . . , and the k-th row, and is ended at the time point when the reset signal of the k-th row is subtracted from the captured image signal of the k-th row.

As described above, according to this embodiment, since the captured image signal is sequentially read from the row subsequent to the final row from which the reset signal is read, the time until the captured image signal is read after the charge holding portion 2 is reset is constant all over the rows. Accordingly, the dark current generated in the charge holding portions 2 can be made to be uniform in the row direction, thereby obtaining high-quality captured image signals with the shading in the row direction suppressed.

Since the reset signal read in the final frame among the repeatedly-read reset signals is subtracted from the captured image signals, it is possible to remove the noises such as fixed pattern noises and random noises associated with the captured image signals and the reset signals, thereby obtaining high-quality image signals, which are similar to those of the first embodiment.

### Third Embodiment

A third embodiment of the invention will be described below. The configuration of the solid-state imaging device according to this embodiment is similar to the configuration (FIG. 4) described in the second embodiment and thus an omission thereof is omitted here.

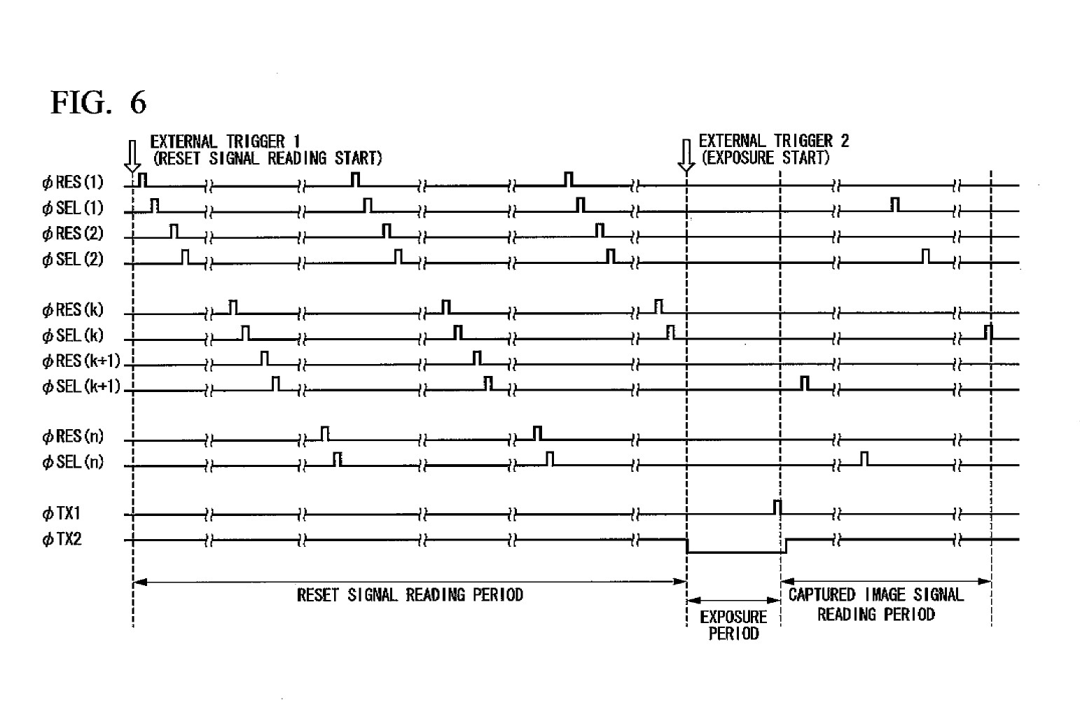

The operation of the solid-state imaging device according to this embodiment will be described with reference to the timing diagram shown in FIG. 6. FIG. 6 is different from FIG. 5, in that the reading of the reset signal is not performed in the exposure period.

The operations until the start of exposure are the same as the second embodiment and the repeated reading of the reset signal is performed when the first trigger signal is input to the trigger receiver 37. When the second trigger signal is input to the trigger receiver 37, the reading of the reset signal is ended and the exposure of all the pixels is started. Here, the final row from which the reset signal is read is the k-th row and the information indicating the row position thereof is stored in the memory unit 38.

After a predetermined exposure period, the transfer control signal φTX1 is changed to the H level to turn on the transfer portions 3 of all the pixels at the same time whereby the optical charges stored in the photoelectric conversion elements 1 are transferred to the charge holding portions 2 in a bundle. That is, the exposure is ended. After the exposure is ended, the reading of the captured image signal is started from the (k+1)-th row subsequent to the final row from which the reset signal is read on the basis of the information stored in the memory unit 38. The subsequent operations are the same as the second embodiment and thus an omission thereof is omitted here.

As described above, according to this embodiment, since the reading of the reset signal is not performed in the exposure period, the leakage of charges from the photoelectric conversion elements 1 to the charge holding portions 2 accompanied with the reset operation on the charge holding portions 2 or noises resulting from the reset operation in the exposure period are suppressed. Accordingly, it is possible to obtain high-quality captured image signals, thereby obtaining high-quality image signals.

### (Camera System)

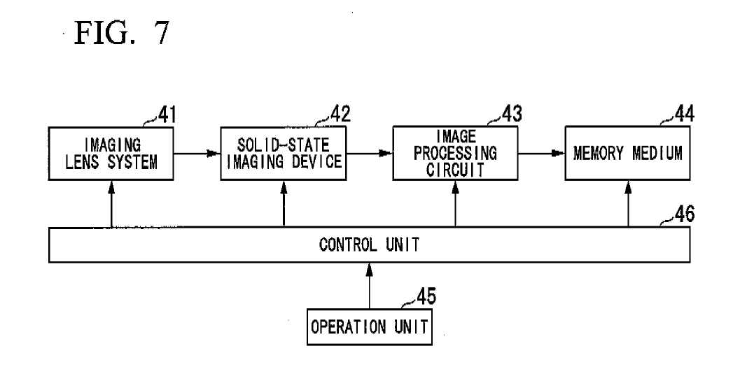

A camera system employing the solid-state imaging device according to one of the first to third embodiments of the invention will be described below. FIG. 7 is a diagram showing the configuration of the camera system. This camera system includes an imaging lens system 41, a solid-state imaging device 42, an image processing circuit 43, a memory medium 44, an operation unit 45, and a control unit 46.

The imaging lens system 41 forms a subject image on a two-dimensional pixel array of the solid-state imaging device 42. The solid-state imaging device 42 has a global shutter function and a function of outputting a difference signal between a captured image signal and a reset signal. The image processing circuit 43 has a function of performing signal processes such as a color signal process, a gain process, and a white balance process on the output data of the solid-state imaging device 42 to convert the output data into a format which can be stored in the memory medium 44. The memory medium 44 is, for example, a solid memory storing image data.

The operation unit 45 includes a shutter button for performing the operations of imaging start and the like. By user operation of the operation unit 45, the first trigger signal φTRG1 which is a pre-instruction of the exposure start and the second trigger signal φTRG2 which is the instruction of the start of the exposure are generated via the control unit 46. The control unit 46 controls the operations of the camera system. The camera system may include a display panel or the like.

That is, according to the invention, the reading of the reset signal based on the first trigger which is the pre-instruction of the storage start is started before the storage start based on the second trigger which is the instruction of the storage start, and the reset signals corresponding to one frame are read before the storage end. Accordingly, when the exposure time is shorter than the frame reset signal reading time, it is possible to start the exposure just after the second trigger is received, thereby shortening the release time lag.

While the exemplary embodiments of the invention have been described with reference to the accompanying drawings, the detailed constitutions of the invention are not limited to the foregoing embodiments but embrace changes in design to the extent that they do not depart from the concept of the invention.

What is claimed is:

1. A solid-state imaging device comprising:
a pixel unit in which pixels are two-dimensionally arranged in a matrix, each pixel comprising a photoelectric conversion element of which an amount of charges stored therein varies depending on incident light and a charge holding portion which holds the charges stored in the photoelectric conversion element;
a trigger receiver which receives a first trigger which is a pre-instruction to start charge storage in the pixels and a second trigger which is an instruction to start the charge storage;
a storage controller which controls the pixels so as to start and end the charge storage in the pixels of a plurality of rows at the same time after the second trigger is received; and
a reading circuit which reads a reset signal corresponding to one frame before the charge storage is ended by reading the reset signal from each row when the charge holding portion is reset after the first trigger is received, and reads a captured image signal corresponding to one frame by reading the captured image signal corresponding to the charges stored in the photoelectric conversion element from the charge storage start to the charge storage end from each row after the second trigger is received.

2. The solid-state imaging device according to claim 1, wherein the storage controller controls the pixels to start the charge storage after the second trigger is received and the reading of the reset signal is ended.

3. The solid-state imaging device according to claim 1, wherein the reading circuit stops the reading of the reset signal at the same time as the charge storage end and
further comprising: a memory unit which stores position information of the row from which the reset signal is read just before the reading circuit stops the reading of the reset signal; and
a reading controller which determines a position of the row from which the reading circuit starts the reading of the captured image signal, based on the position information stored in the memory unit.

4. The solid-state imaging device according to claim 1, further comprising:
a memory unit which stores the reset signal read by the reading circuit before the charge storage is ended after the second trigger is received, when the reading circuit repeatedly reads the reset signal corresponding to one frame; and
a processing unit which generates a difference signal between the reset signal corresponding to one frame, which is finally stored in the memory unit, and the captured image signal corresponding to one frame.

5. A camera system comprising the solid-state imaging device according to claim 1.
